(19) United States
(12) Patent Application Publication
(10) Pub. No.: US 2026/0180396 A1
(43) Pub. Date: Jun. 25, 2026

(54) ACTUATOR

(71) Applicant: THK CO., LTD., Tokyo (JP)

(72) Inventors: Junichi Iguchi, Tokyo (JP); Marie Horikawa, Tokyo (JP)

(73) Assignee: THK CO., LTD., Tokyo (JP)

(21) Appl. No.: 18/865,076

(22) PCT Filed: May 8, 2023
(86) PCT No.: PCT/JP2023/017291

§ 371 Date: Nov. 12, 2024

(30) Foreign Application Priority Data
May 13, 2022 (JP) 2022-079669

(51) Int. Cl. H02K 7/116; F16H 7/14; F16H 25/20; F16H 25/22; H02K 11/33

(52) U.S. Cl. CPC H02K 7/116; F16H 7/14; F16H 25/20; F16H 25/2204; H02K 11/33

(57) ABSTRACT

The present invention is an actuator (1) including an electric motor (3), a driven device (2), a base plate (16), a belt mechanism (4), and a tension adjusting mechanism (5), in which a through hole (16b) is formed in the base plate (16), and in which the tension adjusting mechanism (5) includes an adjustment plate (40) and an adjustment screw (50).

### TECHNICAL FIELD

The present invention relates to an actuator. Priority is claimed on Japanese Patent Application No. 2022-079669, filed May 13, 2022, the content of which is incorporated herein by reference.

### BACKGROUND ART

In the following Patent Document 1, an electromechanical actuator such as a machine press or the like used in a wide variety of industrial applications is described. This actuator includes a motor (electric motor) and a linear actuator (driven device) that are supported by being adjacent to each other on a mounting plate (base plate).

A screw shaft (driven shaft) of the linear actuator is connected to rotate together with an output shaft (driving shaft) of the motor through a belt and a pulley system (belt mechanism). In the mounting plate, a plurality of slots extending in a horizontal direction with respect to the linear actuator are formed, and the tension of the belt is able to be adjusted by moving the motor along the slots in the horizontal direction.

### CITATION LIST

### Patent Document

Patent Document 1: U.S. Pat. No. 8,823,229

### SUMMARY OF INVENTION

### Technical Problem

In the conventional technology described above, a main body part of the electric motor is mounted on the other plate face side of the base plate such that the driving shaft of the electric motor protrudes to one plate face side of the base plate. In this way, in a case in which the driving shaft of the electric motor passes through the base plate, in addition to a length corresponding to a thickness of the base plate, a length for protruding from the base plate is required for the driving shaft. In that case, the driving shaft becomes long to reduce a load-bearing capacity against a radial load applied from the belt, and, for example, there are problems in that it becomes easy for the driving shaft to be bent and the like.

The present invention is in view of such problems, and an object thereof is to provide an actuator capable of adjusting the tension of a belt delivering torque to a driven shaft of a driven device while improving a load-bearing capacity in the radial direction of a driving shaft of an electric motor.

### Solution to Problem

In order to solve the problems described above, a first aspect of the present invention is an actuator including: an electric motor having a driving shaft; a driven device having a driven shaft; a base plate in which the electric motor and the driven device are mounted in a state in which the driving shaft and the driven shaft protrude from one plate face; a belt mechanism disposed on one plate face side of the base plate and which deliver torque of the driving shaft to the driven shaft; and a tension adjusting mechanism which adjusts tension of the belt mechanism, in which a through hole extending in a first direction in which the driving shaft and the driven shaft approach each other or are separated from each other is formed in the base plate, and the tension adjusting mechanism includes an adjustment plate mounted in a main body part of the electric motor and inserted into the through hole together with the main body part, and an adjustment screw which moves the adjustment plate in the first direction in the through hole.

A second aspect of the present invention is the actuator described in the above-described first aspect, in which the main body part includes a stator, and a reducer.

A third aspect of the present invention is the actuator described in the above-described first aspect or the above-described second aspect, in which the adjustment plate is disposed to be flush with the one plate face of the base plate.

A fourth aspect of the present invention is the actuator described in the above-described first aspect or the above-described second aspect, in which the adjustment screw is screwed into a corner of the adjustment plate.

A fifth aspect of the present invention is the actuator described in the above-described fourth aspect, in which the adjustment plate includes a first plate portion disposed in the through hole, and a second plate portion installed in series with the first plate portion and fixed to the base plate, and the corner of the adjustment plate is a part in which the first plate portion and the second plate portion overlap each other.

A sixth aspect of the present invention is the actuator described in the above-described first aspect or the above-described second aspect, in which the adjustment plate includes a first plate portion disposed in the through hole, and a second plate portion installed in series with the first plate portion and fixed to the base plate, and the second plate portion is fixed to an other plate face on a side opposite to the one plate face of the base plate.

### Advantageous Effects of Invention

According to the present invention, the tension of a belt delivering torque to a driven shaft of a driven device can be adjusted while improving a load-bearing capacity in the radial direction of a driving shaft of an electric motor.

### BRIEF DESCRIPTION OF DRAWINGS

FIG. 1 A perspective view of an actuator according to a first embodiment of the present invention.

FIG. 2 An exploded perspective view of the actuator according to the first embodiment of the present invention.

FIG. 3 A cross-sectional view taken along arrows III-III shown in FIG. 2.

FIG. 4 A perspective view of a base plate, a belt mechanism, and a tension adjusting mechanism according to the first embodiment of the present invention.

FIG. 5 A plan view in which the base plate, the belt mechanism, and the tension adjusting mechanism according to the first embodiment of the present invention are seen from an axis direction.

FIG. 6 A cross-sectional view taken along arrows VI-VI shown in FIG. 5.

FIG. 7 A perspective view of an adjustment plate according to the first embodiment of the present invention.

FIG. 8 A perspective view of a base plate, a belt mechanism, and a tension adjusting mechanism according to a second embodiment of the present invention.

FIG. 9 A plan view in which the base plate, the belt mechanism, and the tension adjusting mechanism according to the second embodiment of the present invention are seen from an axis direction.

FIG. 10 A cross-sectional view taken along arrows X-X shown in FIG. 9.

FIG. 11 A perspective view of an adjustment plate according to the second embodiment of the present invention.

FIG. 12 A perspective view of a base plate, a belt mechanism, and a tension adjusting mechanism according to a third embodiment of the present invention.

FIG. 13 A plan view in which the base plate, the belt mechanism, and the tension adjusting mechanism according to the third embodiment of the present invention are seen from an axis direction.

### DESCRIPTION OF EMBODIMENTS

Hereinafter, each embodiment of the present invention will be described with reference to the drawings.

### First Embodiment

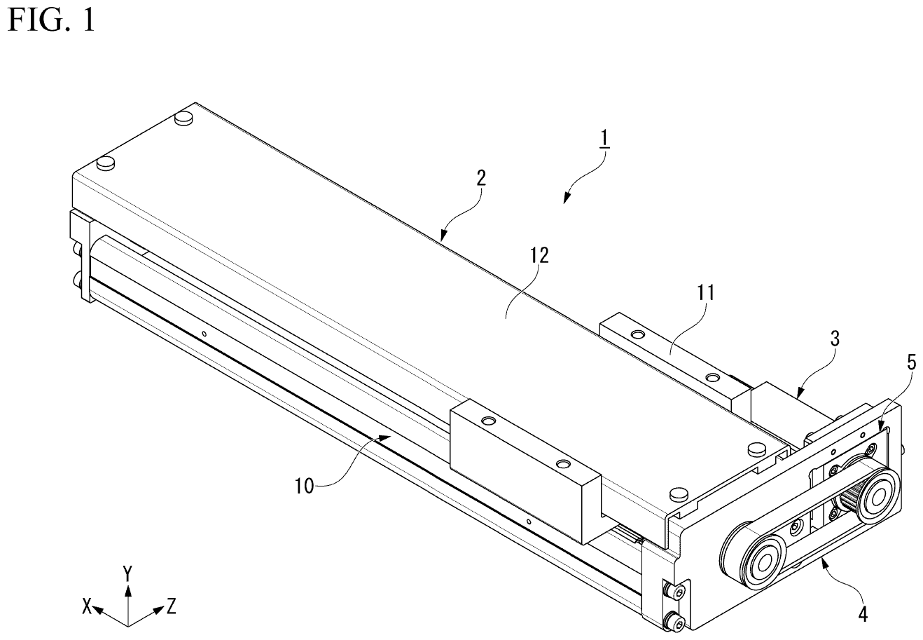

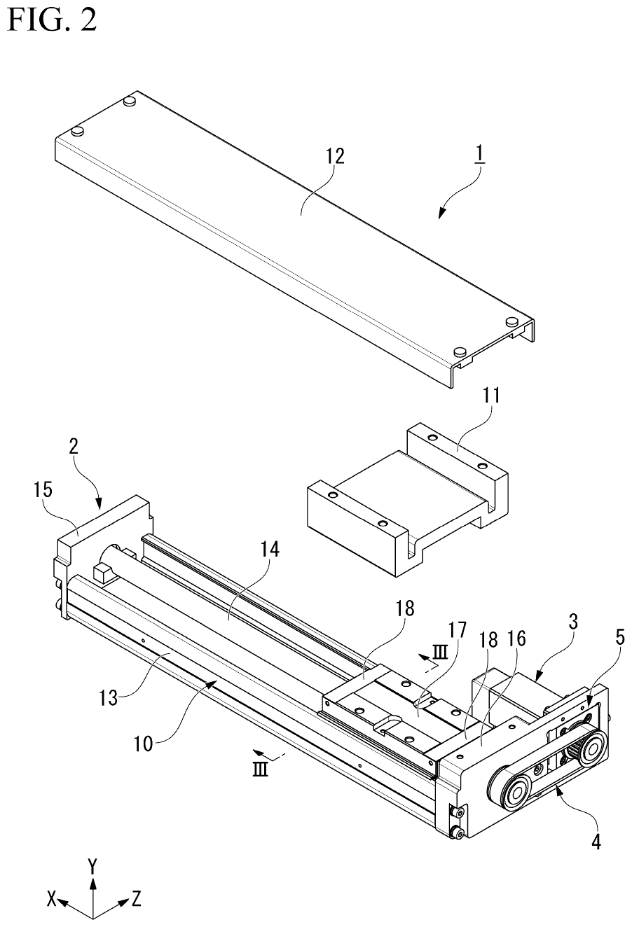

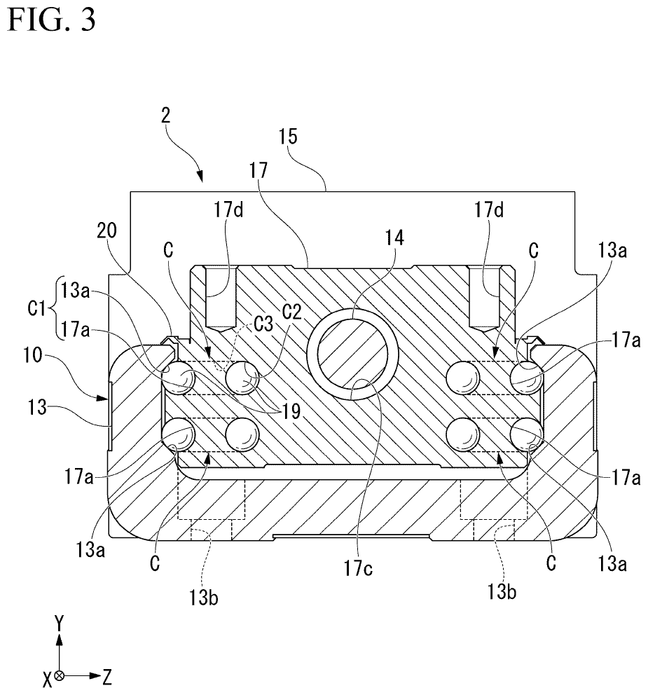

FIG. 1 is a perspective view of an actuator 1 according to a first embodiment of the present invention. FIG. 2 is an exploded perspective view of the actuator 1 according to the first embodiment of the present invention. FIG. 3 is a cross-sectional view taken along arrows III-III shown in FIG. 2.

As shown in FIG. 1, the actuator 1 includes a driven device 2, an electric motor 3 driving the driven device 2, a belt mechanism 4 delivering torque of the electric motor 3 to the driven device 2, and a tension adjusting mechanism 5 adjusting the tension of the belt mechanism 4.

As shown in FIG. 2, the driven device 2 includes a linear motion guiding device 10, a table 11 that is moved by the linear motion guiding device 10, and a cover 12 that is mounted in the linear motion guiding device 10. As shown in FIG. 1, the table 11 is exposed from a gap between the cover 12 and the linear motion guiding device 10 to the outside in a state in which the cover 12 is mounted in the linear motion guiding device 10.

In the following description, an XYZ orthogonal coordinate system is set, and positional relations of members may be described with reference to this XYZ orthogonal coordinate system. An X axis direction is an axis direction in which the screw shaft 14 of the linear motion guiding device 10 shown in FIG. 2 extends. A Y axis direction is orthogonal to the X axis direction and is a normal line direction of the attachment face of the table 11. A Z axis direction is orthogonal to the X axis direction and the Y axis direction and is a direction (a first direction) in which the driven device 2 and the electric motor 3 face each other.

As shown in FIG. 3, the linear motion guiding device 10 includes a rail body 13 having a concave shape in the cross-sectional view and extending in the X axis direction, a screw shaft 14 that is disposed on the inner side of the rail body 13 and extends in the X axis direction, an end plate 15 that axially supports one end of the screw shaft 14, as shown in FIG. 2, a base plate 16 that axially supports the other end of the screw shaft 14, and a mobile body 17 that moves in the X axis direction between the end plate 15 and the base plate 16 in accordance with rotation of the screw shaft 14.

As shown in FIG. 3, on each of inner sides of one pair of side walls of the rail body 13 facing each other in the Z axis direction, a groove is formed, and at the corners of the groove, one pair of rolling body rolling grooves 13a that are separated from each other in the Y axis direction and extend in the X axis direction are formed. In other words, in the rail body 13, a total of four rolling body rolling grooves 13a are formed. In addition, on the bottom wall of the rail body 13 connecting one pair of the side walls, a mounting hole 13b in which a counterbore passing through in the Y axis direction is mounted is formed.

The screw shaft 14 is supported to be rotatable around an axis extending in the X axis direction by the end plate 15 mounted at one end of the rail body 13 in the X axis direction and the base plate 16 mounted at the other end of the rail body 13 in the X axis direction using a bearing, which is not shown in the drawing, disposed in each of the end plate 15 and the base plate 16. A helical groove, which is not shown in the drawing, is formed on the outer peripheral surface of the screw shaft 14.

At the center of the mobile body 17, a screw hole 17c into which the screw shaft 14 is screwed is formed to pass through in the X axis direction. In accordance with this, the mobile body 17 is screw-fed in the X axis direction in accordance with rotation of the screw shaft 14 around an axis extending in the X axis direction. In addition, a rolling body such as ball, which is not shown in the drawing, is interposed between the screw shaft 14 and the screw hole 17c. In a top face of the mobile body 17 directed toward the opening side of the rail body 13 in the Y axis direction, a mounting hole 17d into which the table 11 is mounted is formed.

On both side faces of the mobile body 17 in the Z axis direction, rolling body load rolling grooves 17a facing the rolling body rolling grooves 13a of the rail body 13 are formed. A total of four rolling body load rolling grooves 17a, which include one pair of rolling body load rolling grooves 17a formed in each of the both side faces of the mobile body 17 in the Z axis direction, are formed in correspondence with the rolling body rolling grooves 13a. In addition, on inner sides of the both side faces of the mobile body 17 in the Z axis direction, a total of four no-load rolling body rolling paths C2 corresponding to the respective rolling body rolling grooves 13a are formed to pass through in the X axis direction.

The rolling body load rolling grooves 17a face the rolling body rolling grooves 13a of the rail body 13, and form load rolling body rolling paths C1 rolling the rolling body 19 such as a ball in a state in which a load is applied. The inner diameter of the no-load rolling body rolling path C2 is larger than the outer diameter of the rolling body 19 such that a load is not applied to the rolling body 19. As shown in FIG. 2, the mobile body 17 has rolling body direction switching paths C3 connecting both ends of a load rolling body rolling path C1 and a no-load rolling body rolling path C2 in a lid body 18 mounted on both sides in the X axis direction, and forms an endless circulation path C of the rolling body 19.

A total of four endless circulation paths C, which include one pair of endless circulation paths C formed on each of both sides of the mobile body 17 in the Z axis direction, are formed. In accordance with this, the mobile body 17 is prevented from rotating with respect to one pair of sidewalls of the rail body 13 facing each other in the Z axis direction, and is smoothly guided along the one pair of sidewalls in the X-axis direction. In addition, on both side faces of the mobile body 17 in the Z axis direction, a dust cover 20 that covers a gap with the rail body 13 is mounted with extending in the X axis direction.

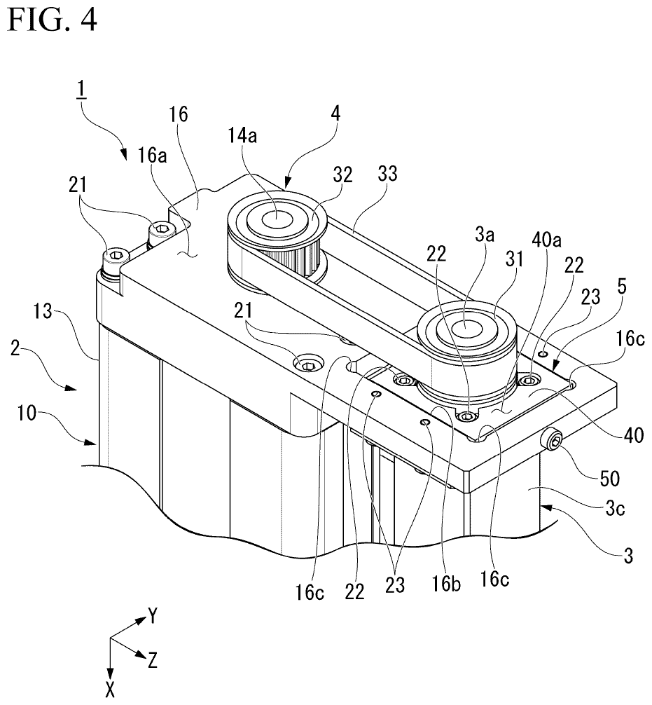

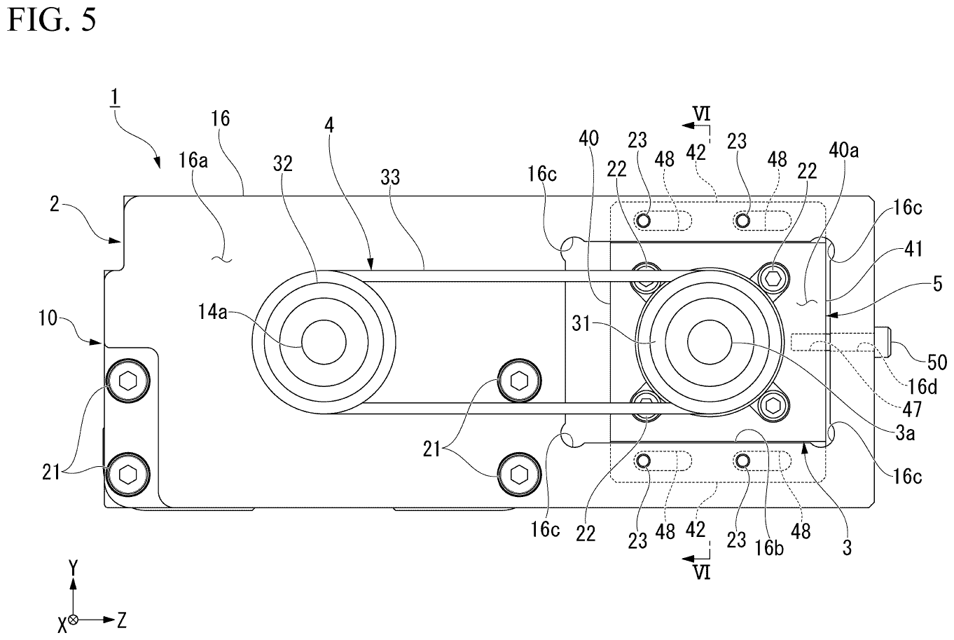

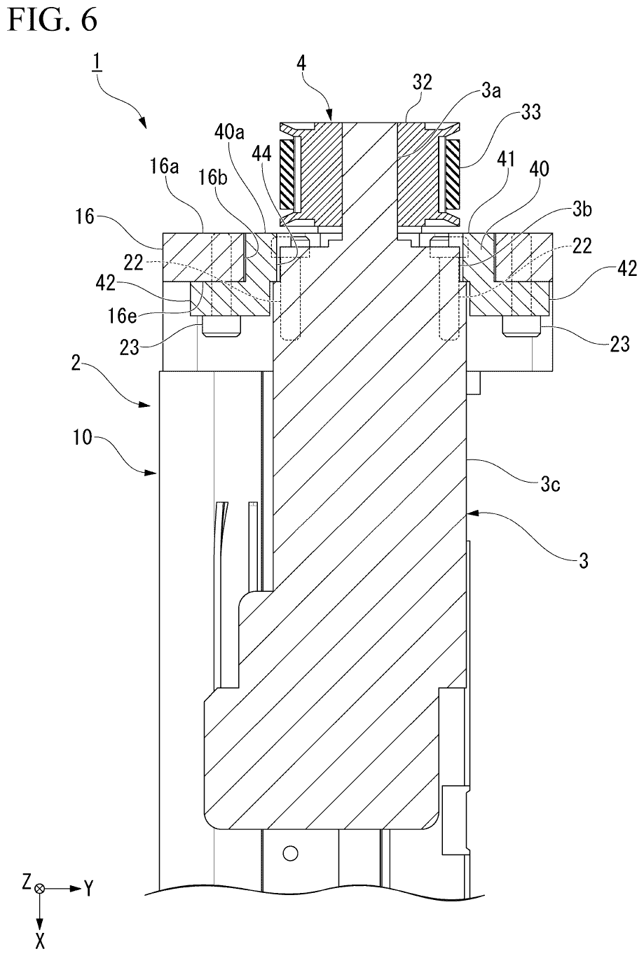

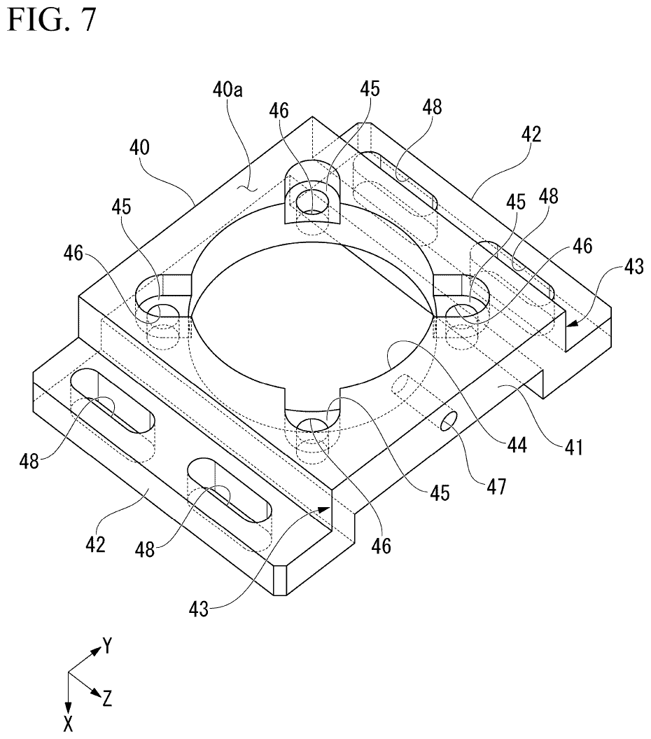

FIG. 4 is a perspective view of the base plate 16, the belt mechanism 4, and the tension adjusting mechanism 5 according to the first embodiment of the present invention. FIG. 5 is a plan view in which the base plate 16, the belt mechanism 4, and the tension adjusting mechanism 5 according to the first embodiment of the present invention are seen from an axis direction. FIG. 6 is a cross-sectional view taken along arrows VI-VI shown in FIG. 5. FIG. 7 is a perspective view of an adjustment plate 40 according to the first embodiment of the present invention.

As shown in FIG. 4, the base plate 16 is attached to an end face of the rail body 13 in the X axis direction using a plurality of screws 21.

On one plate face 16a of the base plate 16, a driven shaft 14a of the driven device 2 and a driving shaft 3a of the electric motor 3 protrude. The driven shaft 14a is an end part of the screw shaft 14 of the linear motion guiding device 10 described above, and passes through the base plate 16 in the X-axis direction. The driven shaft 14a and the driving shaft 3a are separated from each other in the Z axis direction, and extend in parallel in the X axis direction.

The belt mechanism 4 is disposed on one plate face 16a side of the base plate 16. The belt mechanism 4 includes a driving-side pulley 31 mounted in the driving shaft 3a, a driven-side pulley 32 mounted in the driven shaft 14a, and a belt 33 stretched between the driving-side pulley 31 and the driven-side pulley 32. The belt 33, for example, is a timing belt that is engaged with the driving-side pulley 31 and the driven-side pulley 32 having gear shapes. In addition, the belt 33 may be a V belt, a grooved belt, or the like.

As shown in FIG. 5, a through hole 16b, which extends in the Z axis direction (a first direction) in which the driving shaft 3a and the driven shaft 14a approach each other or are separated from each other, is formed on the electric motor 3 side (the +Z side) of the base plate 16. The through hole 16b has a rectangular shape having the Z axis direction as its longitudinal direction in the plan view shown in FIG. 5. At four corners of the through hole 16b, recesses 16c, each of which has an arc shape in the plan view for avoiding interference with the adjustment plate 40 to be described below, are formed.

The tension adjusting mechanism 5 includes an adjustment plate 40 that is mounted in the main body part of the electric motor 3 and is inserted into the through hole 16b together with this main body part and an adjustment screw 50 that moves the adjustment plate 40 in the Z axis direction in the through hole 16b. As shown in FIG. 6, the main body part of the electric motor 3 includes a stator 3c that rotates the driving shaft 3a and a reducer 3b that reduces the rotation speed of the driving shaft 3a.

Opposite to the driving shaft 3a protruding to one plate face 16a side of the base plate 16, the stator 3c is disposed on the other plate face 16e side of the base plate 16. The reducer 3b is interposed between the stator 3c and the driving shaft 3a, and is disposed inside the through hole 16b of the base plate 16. In other words, in this embodiment, the reducer 3b part of the main body part of the electric motor 3 is inserted into the through hole 16b. In addition, in a case in which no reducer 3b is present, the stator 3c may be disposed in the through hole 16b.

The adjustment plate 40 includes a first plate portion 41 that is disposed in the through hole 16b together with the reducer 3b and a second plate portion 42 that is installed in series with the first plate portion 41 and is fixed to the other plate face 16e of the base plate 16. The first plate portion 41 is disposed to be flush with one plate face 16a of the base plate 16.

The first plate portion 41 exhibits a rectangular shape in the plan view shown in FIG. 5. The first plate portion 41 is movable in the Z axis direction inside the through hole 16b by being guided along long sides of both sides of the through hole 16b in the Y axis direction. In other words, small gaps are formed from the through hole 16b on both sides of the first plate portion 41 in the Y axis direction.

As shown in FIG. 7, an opening part 44 is formed at the center of the first plate portion 41. The opening part 44 has a size and a shape for which the main body part (the reducer 3b) of the electric motor 3 can be inserted therein. A plurality (in this embodiment, four) of counterbores 45 and mounting holes 46 are formed with being separated from each other in the peripheral direction on the periphery of the opening part 44 of the first plate portion 41.

As shown in FIGS. 4 and 5, a screw 22 is inserted into the mounting hole 46, and the main body part (the stator 3c) of the electric motor 3 can be mounted therein. The counterbore 45 has a depth for which a head part of the screw 22 that has been inserted into the mounting hole 46 does not protrude from one plate face 16a of the base plate 16. In accordance with this, an interference between the screw 22 and the belt 33 can be avoided.

As shown in FIGS. 5 and 7, an end face of the first plate portion 41 that is directed toward the +Z side (a side opposite to the driven shaft 14a), a screw hole 47 into which the adjustment screw 50 is screwed is formed. The screw hole 47 is formed at a middle position of the first plate portion 41 in the Y axis direction. As shown in FIG. 5, a communication hole 16d, which is configured t to communicate with the screw hole 47 in the Z axis direction, is formed in the base plate 16.

The adjustment screw 50 is screwed into the screw hole 47 of the first plate portion 41 disposed inside the through hole 16b through the communication hole 16d of the base plate 16. In accordance with this, by rotating the adjustment screw 50 around an axis extending in the Z axis direction, the adjustment plate 40 is moved in the Z axis direction, whereby the tension of the belt 33 can be adjusted.

The second plate portion 42 extends from the first plate portion 41 to both sides in the Y axis direction. In the second plate portion 42, long holes 48 used for fixing the adjustment plate 40 at an arbitrary position in the Z axis direction are formed. The long holes 48 extend in the Z axis direction. A total of four long holes 48, which include two long holes 48 formed in each of one pair of second plate portions 42 of both sides of the first plate portion 41 in the Y axis direction, are formed. Fixing screws 23 screwed into the base plate 16 are inserted into the long holes 48.

As shown in FIG. 6, the second plate portion 42 is fixed at the other plate face 16e of a side opposite to one plate face 16a of the base plate 16 using the fixing screws 23. As shown in FIG. 7, the second plate portion 42 overlaps corners 43 of both sides of the first plate portion 41 in the Y axis direction in the X axis direction. In other words, stepped level differences are formed on both sides of the adjustment plate 40 in the Y axis direction, and in accordance with these level differences, the second plate portion 42 is configured to be able to be disposed on the other plate face 16e side of the base plate 16.

As described above, the actuator 1 according to this embodiment includes the electric motor 3 having the driving shaft 3a, the driven device 2 having the driven shaft 14a, the base plate 16 in which the electric motor 3 and the driven device 2 are mounted in a state in which the driving shaft 3a and the driven shaft 14a protrude from one plate face 16a, the belt mechanism 4 that is disposed on one plate face 16a side of the base plate 16 and which deliver torque of the driving shaft 3a to the driven shaft 14a, and the tension adjusting mechanism 5 which adjusts tension of the belt mechanism 4, the through hole 16b extending in the Z axis direction (a first direction) in which the driving shaft 3a and the driven shaft 14a approach each other or are separated from each other is formed in the base plate 16, and the tension adjusting mechanism 5 includes the adjustment plate 40 mounted in the main body part of the electric motor 3 and inserted into the through hole 16b together with the main body part, and the adjustment screw 50 which moves the adjustment plate 40 in the Z axis direction in the through hole 16b.

According to this configuration, as shown in FIG. 5, by rotating the adjustment screw 50 around an axis extending in the Z axis direction, the adjustment plate 40 is moved in the Z axis direction together with the electric motor 3 (the driving shaft 3a), whereby the tension of the belt 33 can be adjusted. In addition, as shown in FIG. 6, the adjustment plate 40 is mounted in the main body part of the electric motor 3 and is inserted into the through hole 16b together with this main body part (the reducer 3b), and thus the driving shaft 3a can be shortened by a length corresponding to the thickness of the base plate 16. In accordance with this, the driving shaft 3a is shortened, and the load-bearing capacity for a radial load received from the belt 33 is improved, whereby it becomes difficult for the driving shaft 3a to bend.

In this way, according to the actuator 1 of this embodiment, while the load-bearing capacity of the driving shaft 3a of the electric motor 3 in a radial direction is improved, the tension of the belt 33 delivering torque to the driven shaft 14a of the driven device 2 can be adjusted.

In addition, in this embodiment, the main body part of the electric motor 3 includes the stator 3c, and the reducer 3b. According to this configuration, by inserting at least one of the stator 3c and the reducer 3b into the through hole 16b of the base plate 16, the driving shaft 3a can be shortened.

In addition, in this embodiment, the adjustment plate 40 is disposed to be flush with the one plate face 16a of the base plate 16. According to this configuration, while an interference between the adjustment plate 40 and the belt 33 is avoided, the length of the driving shaft 3a can be configured to be a necessary minimum.

In addition, in this embodiment, the adjustment plate 40 includes the first plate portion 41 that is disposed in the through hole 16b and the second plate portion 42 that is installed in series with the first plate portion 41 and is fixed to the base plate 16, and the second plate portion 42 is fixed to the other plate face 16e on a side opposite to the one plate face 16a of the base plate 16. According to this configuration, the adjustment plate 40 can be fixed to the base plate 16 while an interference between the second plate portion 42 and the belt 33 is avoided.

### Second Embodiment

Next, a second embodiment of the present invention will be described. In the following description, the same reference signs will be assigned to components that are the same as or equivalent to those of the embodiments described above, and description thereof will be simplified or omitted.

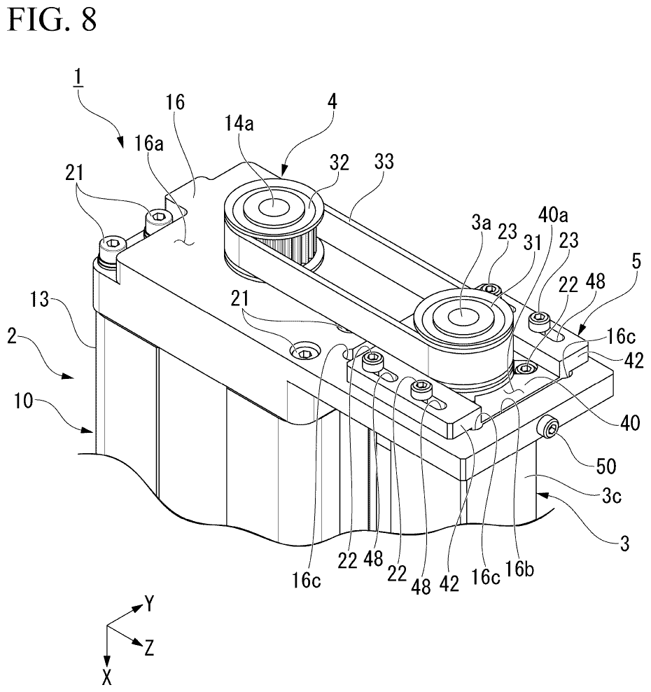

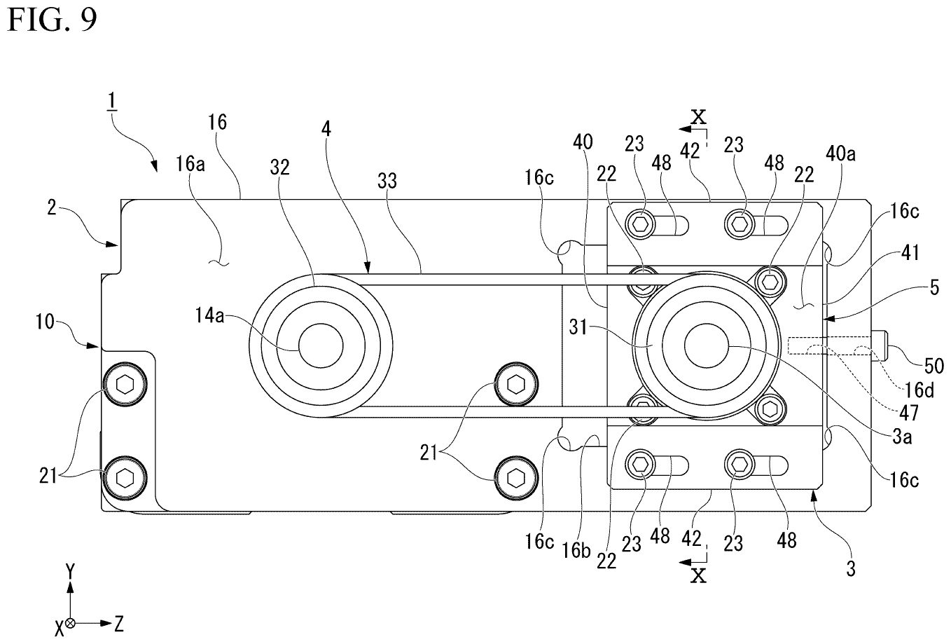

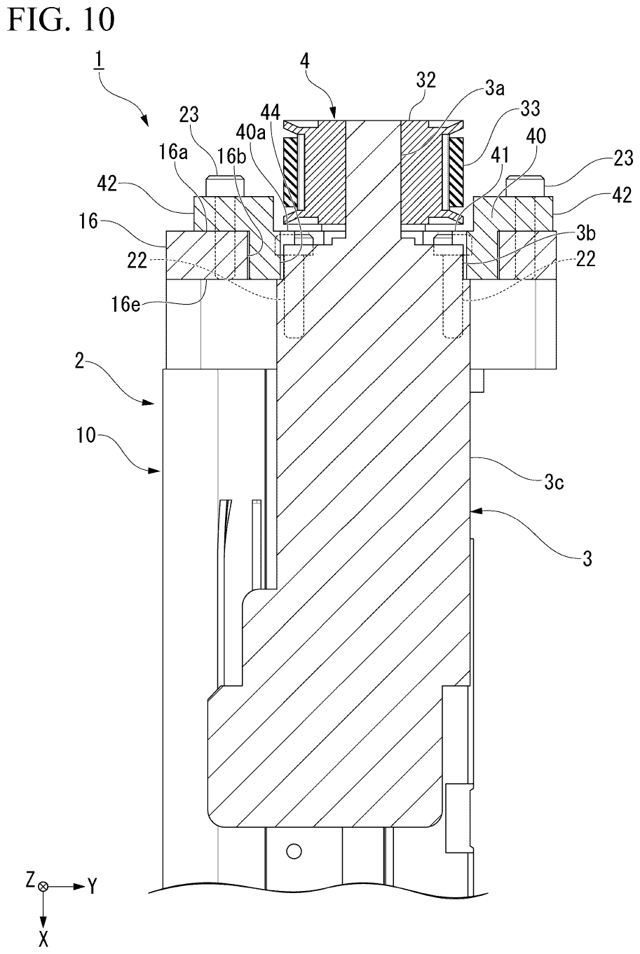

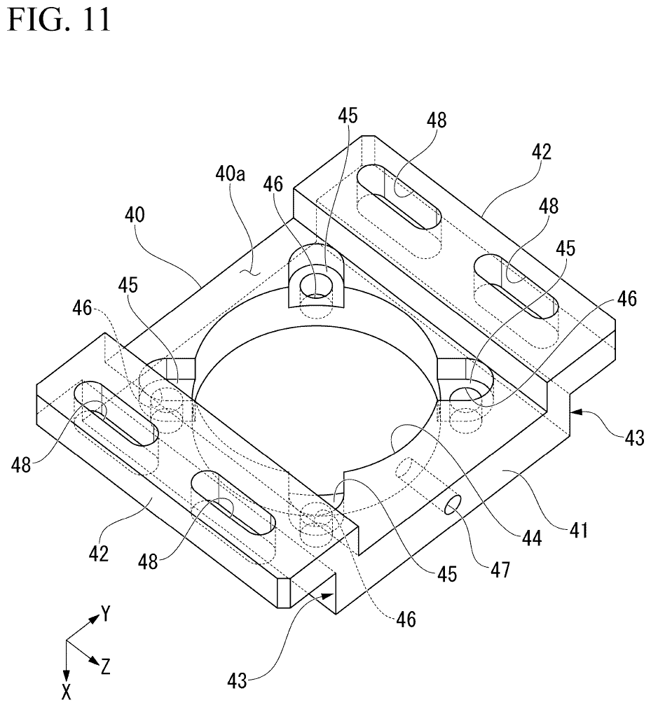

FIG. 8 is a perspective view of a base plate 16, a belt mechanism 4, and a tension adjusting mechanism 5 according to the second embodiment of the present invention. FIG. 9 is a plan view in which the base plate 16, the belt mechanism 4, and the tension adjusting mechanism 5 according to the second embodiment of the present invention are seen from an axis direction. FIG. 10 is a cross-sectional view taken along arrows X-X shown in FIG. 9. FIG. 11 is a perspective view of an adjustment plate 40 according to the second embodiment of the present invention.

As shown in such drawings, in the second embodiment, a second plate portion 42 of the adjustment plate 40 is fixed to one plate face 16a of a base plate 16, which is different from the embodiment described above. In other words, on one plate face 16a of the base plate 16, a driven shaft 14a of a driven device 2 and a driving shaft 3a of an electric motor 3 protrude, and a belt mechanism 4 is disposed, and the second plate portion 42 of the adjustment plate 40 is further fixed to the plate face 16a.

The second plate portion 42 is fixed to one plate face 16a of the base plate 16 using a fixing screw 23. As shown in FIG. 11, the second plate portion 42 overlaps corners 43 of both sides of the first plate portion 41 in the Y axis direction on the −X side thereof. In other words, stepped level differences are formed on both sides of the adjustment plate 40 in the Y axis direction, and, in accordance with these level differences, the second plate portion 42 can be disposed on the one plate face 16a side of the base plate 16.

As shown in FIG. 10, the second plate portion 42 is spaced apart from the belt 33 in the Y axis direction not to interfere with the belt 33. According to this configuration, the length of the driving shaft 3a can be configured to be a necessary medium while an interference between the adjustment plate 40 and the belt 33 is avoided. Since the second plate portion 42 according to the first embodiment shown in FIG. 5 is disposed on a side opposite to the belt 33 with the base plate 16 interposed therebetween, the degree of freedom in design is improved.

### Third Embodiment

Next, a third embodiment of the present invention will be described. In the following description, the same reference signs will be assigned to components that are the same as or equivalent to those of the embodiments described above, and description thereof will be simplified or omitted.

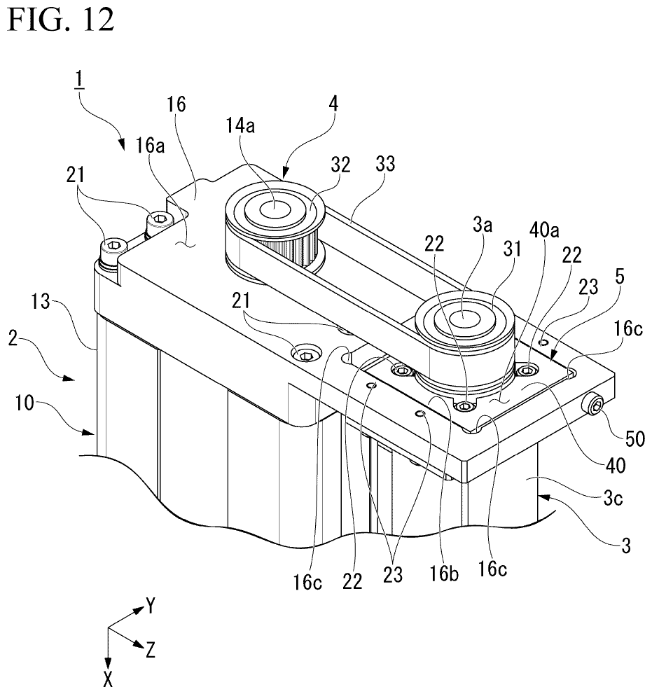

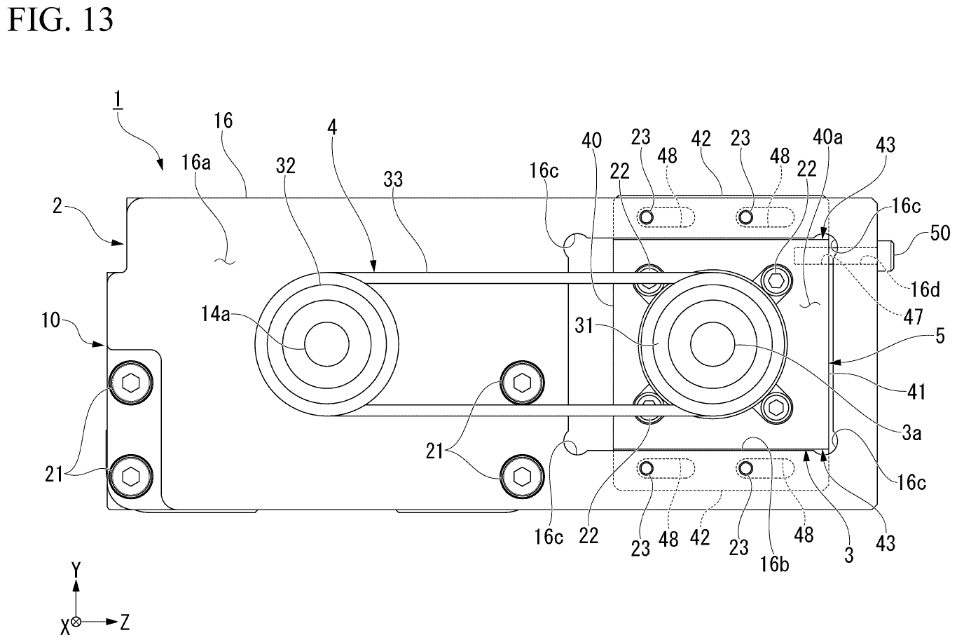

FIG. 12 is a perspective view of a base plate 16, a belt mechanism 4, and a tension adjusting mechanism 5 according to the third embodiment of the present invention. FIG. 13 is a plan view in which the base plate 16, the belt mechanism 4, and the tension adjusting mechanism 5 according to the third embodiment of the present invention are seen from an axis direction.

As shown in FIG. 13, in the third embodiment, an adjustment screw 50 is screwed into a corner 43 of an adjustment plate 40, which is different from the embodiment described above. The adjustment screw 50 according to the third embodiment is inserted into a communication hole 16d communicating with one side (+Y side) of a through hole 16b of a base plate 16 in the Y axis direction, and is screwed into a screw hole 47 formed at the corner 43 of a first plate portion 41.

As shown in FIG. 7 described above, the corner 43 is a part in which the first plate portion 41 and a second plate portion 42 overlap each other. In other words, the screw hole 47 according to the third embodiment is formed in a part of the adjustment plate 40 in which the thickness becomes large. In accordance with this, the strength of the adjustment plate 40 in which the screw hole 47 is formed can be easily secured.

Also according to the third embodiment, by rotating the adjustment screw 50 around an axis extending in the Z axis direction, the tension of the belt 33 can be adjusted by moving the adjustment plate 40 in the Z axis direction. In addition, the first plate portion 41 of the adjustment plate 40 is in sliding contact with a long side of the through hole 16b on one side (+Y side) in the Y axis direction. In accordance with this, management of a gap between the adjustment plate 40 and the through hole 16b in the Y axis direction is performed on only the other side (−Y side) in the Y axis direction, and thus assembly and precision management can be easily performed.

As above, although preferred embodiments of the present invention have been described with reference to the drawings, the present invention is not limited to the embodiments described above. The shapes, the combinations, and the like of the components represented in the embodiments described above are examples, and various modifications can be made on the basis of design requirements and the like in a range not departing from the spirit of the present invention.

For example, in the embodiments described above, although the linear motion guiding device 10 has been shown as the driven device 2, the configuration is not limited to such a configuration. As the driven device 2, a general rotating device having a driven shaft can be used.

In addition, for example, although the configuration in which the adjustment plate 40 is moved by one adjustment screw 50 has been shown in the embodiment described above, a configuration in which the adjustment plate 40 is moved by a plurality of (two or more) adjustment screws 50 may be employed.

### INDUSTRIAL APPLICABILITY

According to the present invention, the tension of a belt delivering torque to a driven shaft of a driven device can be adjusted while the load-bearing capacity of a driving shaft of an electric motor in a radial direction is improved.

### REFERENCE SIGNS LIST

1 Actuator
2 Driven device
3 Electric motor
3a Driving shaft
3b Reducer
3c Stator
4 Belt mechanism
5 Tension adjusting mechanism
14a Driven shaft
16 Base plate
16a One plate face
16b Through hole
16e Other plate face
40 Adjustment plate
41 First plate portion
42 Second plate portion
43 Corner
50 Adjustment screw

1. An actuator comprising:
an electric motor having a driving shaft;
a driven device having a driven shaft;
a base plate in which the electric motor and the driven device are mounted in a state in which the driving shaft and the driven shaft protrude from one plate face;
a belt mechanism disposed on one plate face side of the base plate and which delivers torque of the driving shaft to the driven shaft; and
a tension adjusting mechanism which adjusts tension of the belt mechanism,
wherein a through hole extending in a first direction in which the driving shaft and the driven shaft approach each other or are separated from each other is formed in the base plate, and
wherein the tension adjusting mechanism includes
an adjustment plate mounted in a main body part of the electric motor and inserted into the through hole together with the main body part, and
an adjustment screw which moves the adjustment plate in the first direction in the through hole.

2. The actuator according to claim 1,
wherein the main body part includes
a stator, and
a reducer.

3. The actuator according to claim 1,
wherein the adjustment plate is disposed to be flush with the one plate face of the base plate.

4. The actuator according to claim 1,
wherein the adjustment screw is screwed into a corner of the adjustment plate.

5. The actuator according to claim 4,
wherein the adjustment plate includes
a first plate portion disposed in the through hole, and
a second plate portion installed in series with the first plate portion and fixed to the base plate, and
wherein the corner of the adjustment plate is a part in which the first plate portion and the second plate portion overlap each other.

6. The actuator according to claim 1,
wherein the adjustment plate includes
a first plate portion disposed in the through hole, and
a second plate portion installed in series with the first plate portion and fixed to the base plate, and
wherein the second plate portion is fixed to an other plate face on a side opposite to the one plate face of the base plate.
